(19) United States
(12) Patent Application Publication
(10) Pub. No.: US 2009/0122329 A1
(43) Pub. Date: May 14, 2009

(54) CUSTOMIZING PRINT CONTENT

(75) Inventors: Darrin G. HEGEMIER, Del Mar, CA (US); Darryl R. KUHN, La Jolla, CA (US); David Marc PEACE, Escondido, CA (US); Sean Richard POWELL, San Diego, CA (US)

Correspondence Address: MORRISON & FOERSTER LLP, 12531 HIGH BLUFF DRIVE, SUITE 100, SAN DIEGO, CA, 92130-2040, US

(73) Assignee: SKINIT, INC., San Diego, CA (US)

(21) Appl. No.: 12/267,527

(22) Filed: Nov. 7, 2008

Related U.S. Application Data
(60) Provisional application No. 60/986,283, filed on Nov. 7, 2007.

(51) Int. Cl. G06F 15/00; G06F 17/00; G06F 3/12; G06K 9/03

(52) U.S. Cl. 358/1.9; 715/255; 382/309; 715/274

(57) ABSTRACT

Disclosed herein are methods and apparatus for creating an interactive interface allowing a user to create a virtual design on-screen. Specifications of the design created by the user may be subsequently transmitted to a server for high-resolution rendering and printing on an adhesive appliqué or other material adapted to receive print. In some embodiments, the created product is adapted to fit a particular device, such as a cell phone, laptop, personal digital assistant, snowboard, boat, or motor vehicle. Alternatively, the printed product can be adhesively applied to a portion of a wall, a window, or upon the side of a building. In one embodiment, the interactive interface allows the user to create their own personalized product by using a combination of images, colors, text, and shapes, specified for a particular CAD that will print onto an adhesive skin. In this manner, the adhesive skin can be made to look exactly like the finished product of a personally customized design presented on a computer screen.

### CLAIM OF PRIORITY

This application claims priority to U.S. Provisional Patent Application No. 60/986,283 filed Nov. 7, 2007, the content of which is incorporated herein by reference in its entirety.

### FIELD OF THE INVENTION

The present invention relates generally to the field of image customization. More particularly, the present invention is directed in one exemplary aspect to enabling a user to create customized content for printing upon a substrate that is defined by a specific area.

### SUMMARY OF THE INVENTION

Various embodiments of the present invention are directed to a rich image compositing tool adapted to enable a user to create and purchase a custom design for adhesive application to a specific surface of an electronic device or other specifically shaped physical object. An application resident within memory of a client device allows the user to create the design by layering and manipulating images, shapes, and text upon selectable surfaces of the specified device. The user may select a specific device from a library of surface templates (e.g., from within a library of CAD files) or create a unique template by defining dimensions and/or using a cut tool from within the application. In this manner, a user may design adhesive prints bearing unique shapes or comporting with the surfaces of a particular device.

In some embodiments, the application is adapted to create an image that can be utilized by a variety of manufacturing processes. The image can be transferred through an export function of the application as a file type for use in laser etching, laser converting or cutting, photo printing, or pressure sensitive film printing. In some embodiments, the image can be converted into large or small formats for use in a variety of applications such as automotive, consumer electronics, home interiors, paint on demand systems for painting substrates such as metal and plastic, direct print systems such as UV ink printing on plastic, metal, tile, and ceramic, as well as other applications.

In a first aspect of the invention, a method is disclosed. In one embodiment, the method comprises: providing a first application to a user, wherein the first application is adapted to enable the user to graphically edit a copy of an image associated with a device template; receiving a specification from the user, wherein the specification is adapted to describe an edited copy of the image; creating a rendered image according to the specification; and printing the rendered image.

In a second aspect of the invention, a computer readable medium is disclosed. In one embodiment, the computer readable medium comprises instructions which, when executed by a computer, perform a process comprising: receiving a set of data indicating dimensions of at least one surface configuration; displaying a visual representation of said at least one surface configuration; receiving a set of commands comprising graphical edits to said at least one surface configuration; creating a specification from the set of commands, wherein the specification is adapted to indicate an edited version of said at least one surface configuration; and transferring the specification to a remote device, wherein the remote device is adapted to generate a rendered image from the specification, and wherein the remote device is adapted to print the rendered image.

In a third aspect of the invention, an apparatus is disclosed. In one embodiment, the apparatus comprises: a file server adapted to provide an application to a user, wherein the application is adapted to enable the user to create a design upon a visual representation of a specified area; a content library adapted to enable the user to download data comprising visual representations of specified areas; a receiving module adapted to receive a specification of a design created by the user; a rendering module adapted to generate a rendered image from the specification received at the receiving module; and a print module adapted to print the rendered image.

### BRIEF DESCRIPTION OF THE DRAWINGS

FIG. 1 is a block diagram illustrating an exemplary network topology according to one embodiment of the present invention.

FIG. 2 is a flow diagram illustrating an exemplary method of implementing an interactive interface according to one embodiment of the present invention.

FIG. 3 is a diagram of a surface of an electronic device which can support adhesive application of a skin created according to one embodiment of the present invention.

FIG. 4 is a flow diagram illustrating an exemplary method of receiving customization data according to one embodiment of the present invention.

FIG. 5 is a screen capture of a graphical user interface for use with an interactive application according to one embodiment of the present invention.

FIG. 6 is a representation of an image being rotated upon a canvas stage according to one embodiment of the present invention.

FIG. 7 is a representation of a canvas stage containing a textual overlay created with an interactive application according to one embodiment of the present invention.

FIG. 8 is a flow diagram illustrating an exemplary method of providing a selected image to a server according to one embodiment of the present invention.

FIG. 9 is a flow diagram illustrating an exemplary method of rendering and printing a skin created by an interactive application according to one embodiment of the present invention.

### DETAILED DESCRIPTION OF THE EXEMPLARY EMBODIMENTS

As used herein, the term “application” includes without limitation any unit of executable software which implements a specific functionality or theme. The unit of executable software may run in a predetermined environment; for example, a downloadable Java Xlet™ that runs within the JavaTV™ environment, or a web browser.

As used herein, the terms “computer program” and “software” include without limitation any sequence of human or machine cognizable steps that are adapted to be processed by a computer. Such may be rendered in any programming language or environment including, for example, C/C++, Fortran, COBOL, PASCAL, Perl, Prolog, Python, MATLAB, assembly language, scripting languages (e.g., ActionScript), markup languages (e.g., HTML, SGML, XML, VOXML), functional languages (e.g., APL, Erlang, Haskell, Lisp, ML, F# and Scheme), as well as object-oriented environments such as the Common Object Request Broker Architecture (CORBA), Java® (including J2ME, Java Beans, etc.).

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “module” refers to any type of software, firmware, hardware, or combination thereof that is designed to perform a desired function.

As used herein, the term “network” refers generally to any type of telecommunications or data network including, without limitation, cable networks, satellite networks, optical networks, cellular networks, and bus networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, hybrid fiber coaxial, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, TCP/IP, H.323, etc.).

As used herein, the term “processing” may utilize all types of digital and graphics processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable compute fabrics (RCFs), array processors, and application-specific integrated circuits (ASICs).

In the following description of exemplary embodiments, reference is made to the accompanying drawings in which it is shown by way of illustration specific embodiments in which the invention can be practiced. It is to be understood that other embodiments can be used and structural changes can be made without departing from the scope of the embodiments of this invention.

Various embodiments of the present invention are directed to a web application that enables a user to create and customize the appearance of an adhesive appliqué, sticker, decal, decorative layer, non-adhesive image, photo-print, device shell or device skin. The created product may then be printed and subsequently applied to a surface in order to personalize the item or to increase aesthetic appeal. In some embodiments, the printed product is adapted to fit a specific surface of an electronic device, such as a mobile device (e.g., a cell phone), laptop computer, personal digital assistant (PDA), video game console (e.g. Xbox 360®), handheld device, or other electronic system. The product may alternatively be applied to non-electronic devices, such as snowboards, books, CD cases, as well as other household items. In other embodiments, the printed product may be adapted for placement upon constructed surfaces such as walls, windows, or the sides of buildings. In still other embodiments, the product may be used a wrap or surface layer for a vehicle such as a car or boat. Myriad other applications are also possible.

The web interface used for modifying the appearance of a printed product may be adapted to display a variety of features for the user to employ during their creation process. For example, in some embodiments, the user may upload images from a local device (e.g., a digital camera), or from a remote device (e.g., an external website such as Facebook®, Snapfish®, an external image library, or from a user-specified web address). In some embodiments, the user may add and position stylized text to the creation using a number of selectable fonts, add and position one or more scalable images to the design, or add certain effects or filters to the image (e.g., fade, Guassian blur, sharpen, brighten, drop-shadows, etc).

Although embodiments of the present invention may be described and illustrated herein in terms of a web-based application, it should be understood that embodiments of this invention are not so limited, but are additionally applicable to computing systems employing other communication protocols (including, without limitation, e-mail, TELNET, file transfer protocol (FTP), internet relay chat (IRC), direct connection, etc.), as well as stand-alone systems. Furthermore, although embodiments of the invention may be described and illustrated herein in terms of skins adapted for use upon formed devices or premade templates, it should be understood that embodiments of the invention are not necessarily limited to the generation of content for formed devices or premade templates, and may also include products printed from a customized or user-specified set of input. Additionally, although embodiments of the invention may be described and illustrated in terms of an application adapted to facilitate user customization of the appearance of an adhesive product, the printed product need not necessarily be adhesive, and may instead utilize one of a myriad number of non-adhesive surfaces (bond paper, photographic paper, film, plastic, cardboard, etc.).

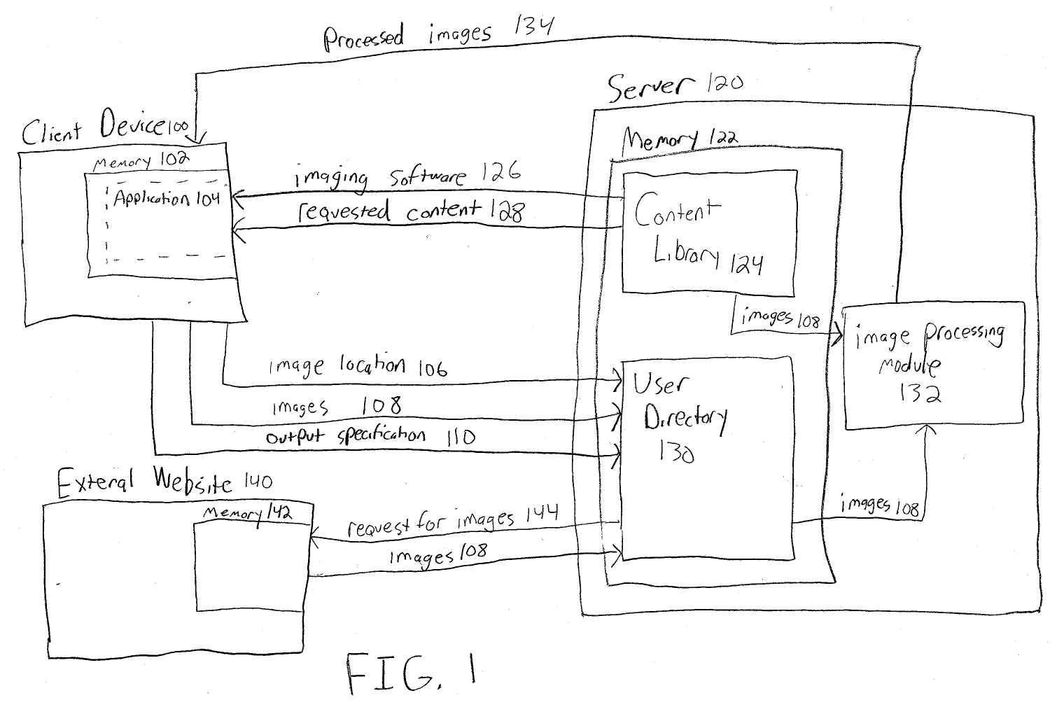

FIG. 1 is a block diagram illustrating an exemplary network topology according to one embodiment of the present invention. As shown by the figure, a client device 100, a server 120, and an external website 140 are communicatively coupled over a network (e.g., the Internet).

The client device 100, the server 120, and the external website 140 may each comprise a memory unit (depicted in FIG. 1 as memory 102, memory 122, and memory 142) for enabling digital information to be stored, retained, and subsequently retrieved. Memory 102, memory 122, and memory 142 may comprise any combination of volatile and non-volatile storage devices, including without limitation, RAM, DRAM, SRAM, ROM, and/or flash memory. Note also that memory 102, memory 122, and memory 142 may be organized in any number of architectural configurations utilizing, for example, registers, memory caches, data buffers, main memory, mass storage, and/or removable media.

In one embodiment, a user operating the client device 100 initially navigates to a website hosted by the server 120. This connection may be established via a web browser, navigator, or other such communication software. Upon connecting to the website, the user may then download imaging software 126 for use within the client device 100. Once executed, the imaging software 126 may be presented as an application 104 resident within the memory 102 of the client device 100.

In one embodiment, the imaging software 126 may be developed in a scripting language (e.g., ActionScript, which is a scripting language based on ECMAScript), but other languages may be utilized in the alternative. In one embodiment, Adobe Flash™ may be used as a development environment for the creation of imaging software 126.

Once the imaging software 126 has been deployed and installed, the application 104 may then be executed. Note that the application 104 may provide its interface to the user in several different ways. In one embodiment, for example, the application 104 may be executed using Adobe Flash Player™, which is a multimedia and application player that can be integrated within a web browser. In another embodiment, a Visual Basic wrapper application may be used in the alternative. A myriad of other application frameworks may also be used as a means for executing the application 104 according to embodiments of the present invention.

The imaging software 126 may include a configuration file (e.g., an XML file) indicating which features, colors, options, and layouts are available in the present deployment of imaging software 126. Advantageously, this enables a single executable file to be tailored to accommodate a variety of specific servicing needs or operational environments. In one embodiment, the application 104 initially loads the configuration file to adjust all settings, change colors and graphics within the interface, and toggle key features (including text labels and phrases used throughout the application for interchangeable support for multiple languages).

In one embodiment, once the application 104 has successfully launched, the user is presented with an interface for customizing content for use within the printed product. In one embodiment, the interface consists of a main console or icon bar, a plurality of interchangeable panels containing controls and components, a main stage area, and a plurality of navigational controls (e.g., pan and zoom controls). In another embodiment, the interface is adapted for use with a touch-screen panel, and includes larger buttons, browser modules, and third party image effects. Various other interface configurations may also be utilized according to the scope of the present invention. Note that these interface configurations may in part depend upon operating characteristics of the client device 100 (for example, whether the client device 100 can be assumed to have an active network connection, an upload/download speed, graphics capabilities, etc.).

Some embodiments feature zoom and pan controls enabling the user better control over his design as it is being edited. For example, in some embodiments, a zoom slider or mouse-wheel allows the user to zoom in and out of any surface of the design in order to become more precise with their editing. In some embodiments, a pan control containing a center-draggable button allows the user to drag and drop the entire stage for any side or surface. In one embodiment, the pan control may be activated by holding a button while dragging the stage by clicking and holding any location within it. In one embodiment, the pan control also contains a set of clickable arrows adapted to pan the stage continuously in a given direction (e.g., up, down, right, left, etc.).

During certain points of the execution of the application 104, the user may choose to request content from the server 120 in order to facilitate the content creation process. The requested content 128 may include, without limitation, device forms or templates, selectable fonts, images, shapes, and downloadable effects. In one embodiment, the requested content 128 may be selected from one or more content libraries 124 disposed within the memory 122 of the server 120.

If the user does not wish to use the content stored within the content library 124, other options are also available. The user may transfer to the server 120 images 108 stored locally within the memory 102 of the client device 100. In one embodiment, these images 108 may be stored in a user directory 130 disposed within the memory 122 of the server 120. Alternatively, if the user wishes to specify the use of images 1084 stored within the memory 142 of an external website 140, the user may specify to the server the location 106 of the images 108. The server can generate a request for the images 144 to the external website 140, and the images 108 can then be downloaded to the corresponding user directory 130.

In some embodiments, in order to facilitate a more expedient representation of an image as it is being manipulated and/or edited on the interface screen of the application 104, an image processing module 132 may be used within the server 120 in order to generate a lower resolution image handle. The processed images 134 may contain a lower resolution than the raw images 108 stored within the memory 122 of the server 120, but may load faster within the application 104 and respond quicker to image editing operations.

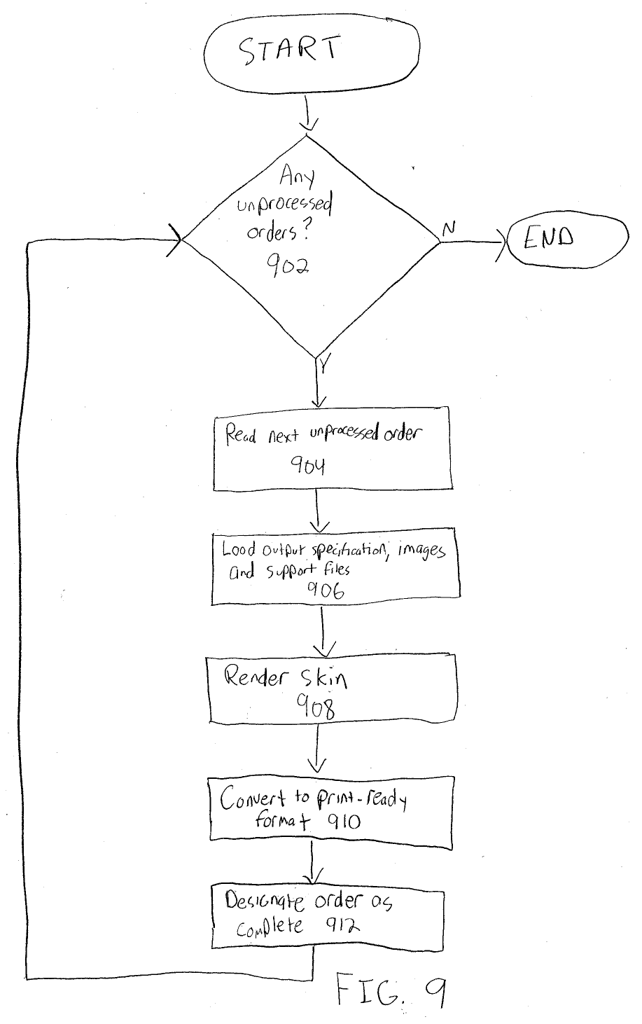

Once the user is satisfied with his creation on-screen, an output specification 110 of the final product may then be transmitted to the user directory 130. A composite of the images 108 and other selected content may then be rendered at its original resolution, converted into a print-ready format, and then scheduled for printing by a print module or outside agency. This process is discussed in more detail below (see FIG. 9 and accompanying text).

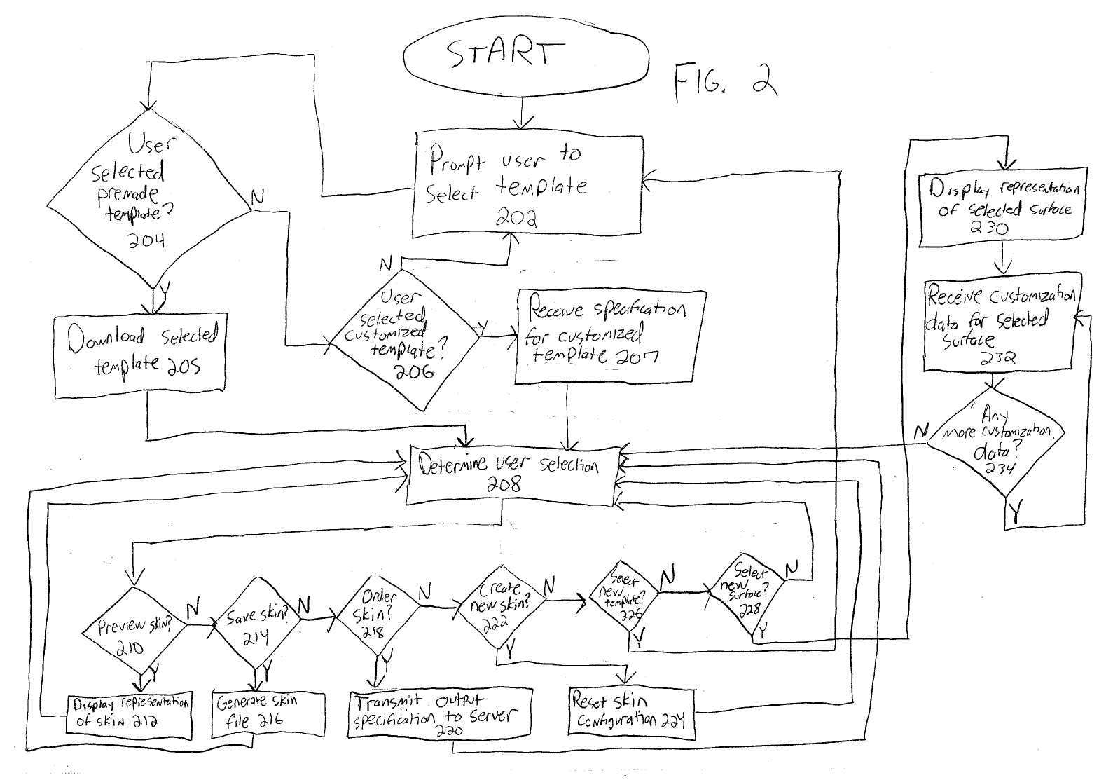

FIG. 2 is a flow diagram illustrating an exemplary method of implementing an interactive interface according to one embodiment of the present invention.

At block 202, the user is prompted to select a template. The template is a descriptor of the general shape, form, and dimensions of a given structure, device, or printable area, and may include one or more customizable print surfaces. Each surface may contain a number of empty regions which may support electronic devices featuring modules which receive electronic equipment, user input, or connections with electronic peripherals.

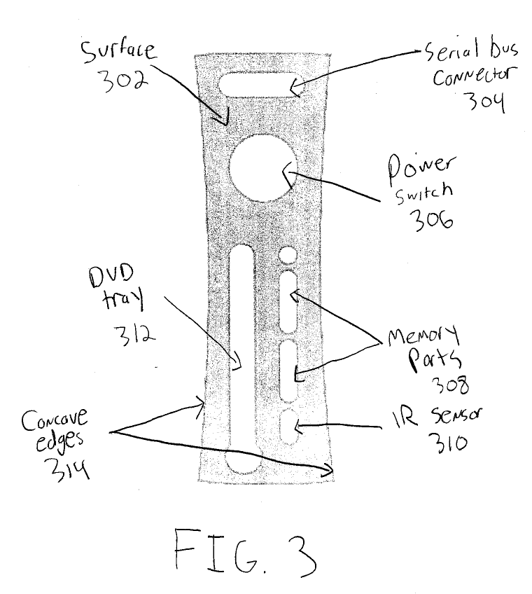

A visual representation of an exemplary surface 302 is depicted in FIG. 3, which illustrates the front face of a popular video gaming console. As shown by the figure, the surface 302 is defined by in part by its concave edges 314, as well as the regions reserved for a serial bus connector 304, a power switch 306, a series of memory ports 308, an infrared sensor 310, and a DVD tray 312.

Referring again to FIG. 2, the system determines whether the user wishes to design a skin from a premade template at block 204. The premade templates may be CAD files downloadable from an external device (e.g., the content library 124 of server 120 in FIG. 1), or provided within a library as part of the initial download of the imaging software 126.

In one embodiment, a desired template is dynamically loaded at run time, thus enabling the user to receive only relevant templates, while simultaneously eliminating dependencies on the storage limitations of the client device 100. Thus, in one embodiment, templates are downloaded only after being selected by the user (as shown in block 202), which prevents the application 104 from continually requiring updates as new device templates are created. Additionally, this may also prevent unnecessary templates from cluttering up space within the memory 102 of the client device 100.

In some embodiments, a package of templates is provided to the client device 100 according to information about the user that has been determined from the server 120. For example, if the user has indicated that he uses a Nokia® cell phone, only templates for Nokia® cell phones are provided with the imaging software 126 package.

In one embodiment, each device template includes an extensible markup language (XML) file which defines the coordinates and size of the selected device, as well as an accompanying image file (e.g., PNG or SWF) file which provides the print shape of the selected device to the application 104.

The XML file may be a simple text file containing all of the size and coordinate information of the selected device, the location of image files for use upon surfaces associated with the device, data indicating how each image is to be displayed upon a respective surface, and may include other author-specified regions to define specific behaviors, such as limiting editable text or auto-placing special graphics.

The image file provides a visual representation of the underlying surfaces of a device or product. In some embodiments, the image file utilizes a transparent alpha channel in order to clearly depict an image overlay upon the surface of the device. Optionally, the transparency level of the alpha channel may be adjustable by the user, thus enabling the user to combine the image with the background in order to create the appearance of partial transparency.

If the user does not wish to work from a premade template, he may opt instead to create a customized template by providing one or more cut paths to a base representation, thereby enabling the user to define the dimensions and/or boundaries of the customized template. This is shown in block 206. The customized template may be used, for example, to enable the user to create adhesive labels with specific shapes (e.g., the shape of a human, an automobile, a street sign, a heart, etc.). In one embodiment, the application 104 may contain an automated process for assisting the user with designating a particular cut path using a selectable cut tool. Server-side algorithms and advanced mathematical image data analysis may be used to identify edges within the image, to help the user quickly plot points within a path to automatically draw, to smooth curves accurately around their desired cutout subject, or to translate lines into a final cut path of Bezier curves.

In one embodiment, the cut paths provided by the user are processed and recorded in an XML file, and a corresponding image file is generated. This is shown in block 207. The XML file generated for the custom template may take the same format as an XML file of a premade template according to some embodiments. Once the appropriate template has been selected, the process proceeds at block 208, at which point the user is presented with a number of options from a graphical user interface (GUI) associated with the application 104.

At block 210, if the user has opted to preview the skin, a representation of the skin is displayed to the user on-screen at block 212. As stated above, the previewed skin may utilize lower resolution versions of the image actually selected in order to increase the speed of graphics processing, or to otherwise accommodate performance limitations associated with the client device 100. In some embodiments, a composite of the creation may be generated directly into a staging area associated with the application 104, and thus a separate preview option may be unnecessary.

In some embodiments, the preview provides the user with a top-down perspective at the entire skin which they have designed. The displayed preview may also be navigable by the user, thereby enabling the user to select a specific surface for which to view. This feature can greatly assist the user with designing templates that include a large number of frames or surfaces.

In some embodiments, the user may be provided a selector for determining a resolution at which to view the preview. The selector can be used to enable a user with a higher-performance machine to edit and manipulate images at their original resolution, or for selecting a lower resolution version for faster image editing operations. In some embodiments, the preview displayed on-screen is adapted to appear substantially identical to the skin after being rendered and printed.

At block 214, if the user wishes to save the skin, a skin file may be written to memory 102. In one embodiment, the skin file is stored in the same format as the specification for the template (e.g., an XML file containing all of the size and coordinate information of the selected device, the location of image files for use upon surfaces associated with the device, and data indicating how each image is to be displayed upon a respective surface). Local storage enables the user to work on the skin via the application 104 even when a network connection is not presently available. Optionally, the saved skin file may also be written to a remote location (e.g., the user directory 130 of the server 120 of FIG. 1) for backup or archival purposes.

In some embodiments, a save state is continually created which specifies the user's most current design progress. Advantageously, the save state enables a user to recover their design in the event that they accidentally terminate their connection the site, their web browser crashes, there is a power outage, or other similar circumstance. Thus, when the user returns to the site, they may be prompted with the option of loading their most recent save state. In some embodiments, save states are automatically deleted from the user directory 130 upon expiration of a certain time period or occurrence of a specific activity (e.g., 30 days since a file was edited).

In some embodiments, the state is saved after each image editing operation. This can be used to implement Undo/Redo functionality from within the application 104. Keeping a running history of states allows the user to rollback to previous states if desired.

At block 218, if the user wishes to order the skin, the final version of the specification may be transmitted to the server at block 220. In one embodiment, the specification may contain a flag or other marker indicating that the skin is ready to be prepped for rendering. Alternatively, an indication may be sent from the client device 100 to the server indicating the existence of an unprocessed order (e.g., as written to a database, queue, schedule, list, text file, or other similar data structure).

At block 222, if the user wishes to create a new skin, the skin configuration data may be reset at block 225. In one embodiment, the present configuration data is erased and a cached version of the original template is loaded into memory. Optionally, the application 104 may query the user as to whether he wishes to save the current skin file before the new skin file is created.

At block 226, if the user wishes to create a new template, control proceeds per block 202. Optionally, the application 104 may query the user as to whether he wishes to save the current skin file before selecting a new template.

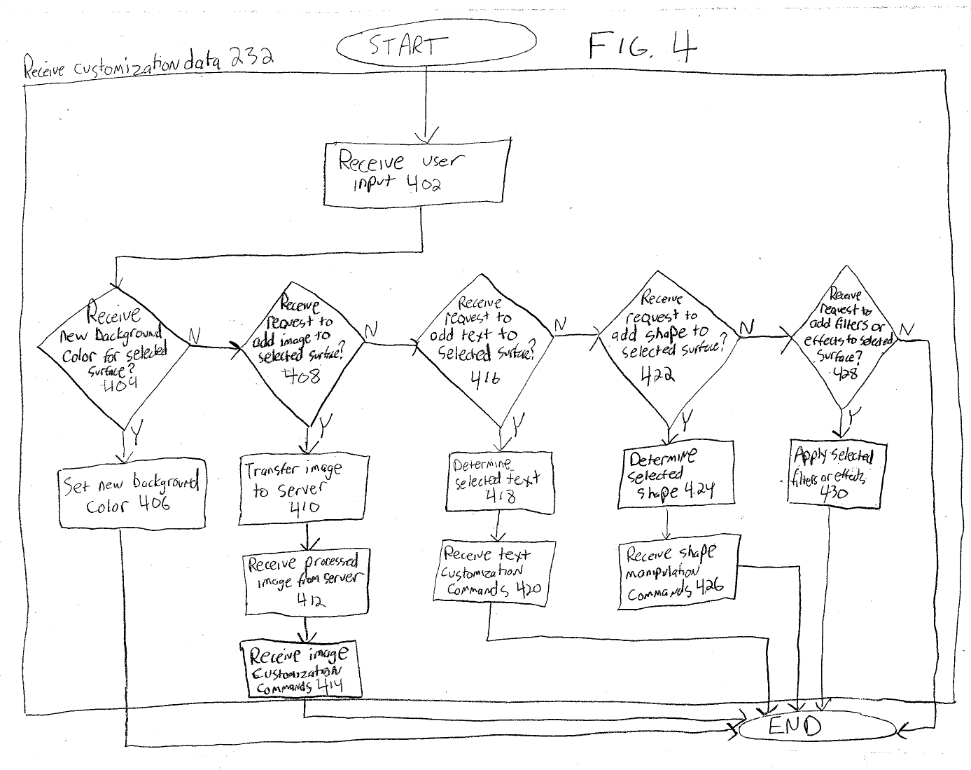

At block 228, if the user wishes to select a new surface, the system determines which surface has been selected, and a representation of that surface may then be displayed in a staging area of the application 104 (block 230). The user may then customize this surface according to his specific design preferences. This is depicted at block 232. Note that various methods of surface customization that are supported by the application 104 are subsequently described below (see, e.g., FIG. 4 and accompanying text).

In one embodiment, each surface or “canvas stage” may contain a virtual representation of the physical area that will be designed and ultimately printed. A canvas stage may contain any number of user objects (e.g., shapes, texts, flows, etc.) which can be manipulated by the user (added, deleted, moved, centered, scaled, rotated, faded, etc.) according to the base functionality provided in an object parent class. In some embodiments, a canvas stage includes an original layered stack of containers, masks, and templates adapted to properly display a fitted background image or color. The canvas stage may also contain a set of graphical or user objects as well as one or more mask areas adapted to hide regions situated outside the shape of a given surface.

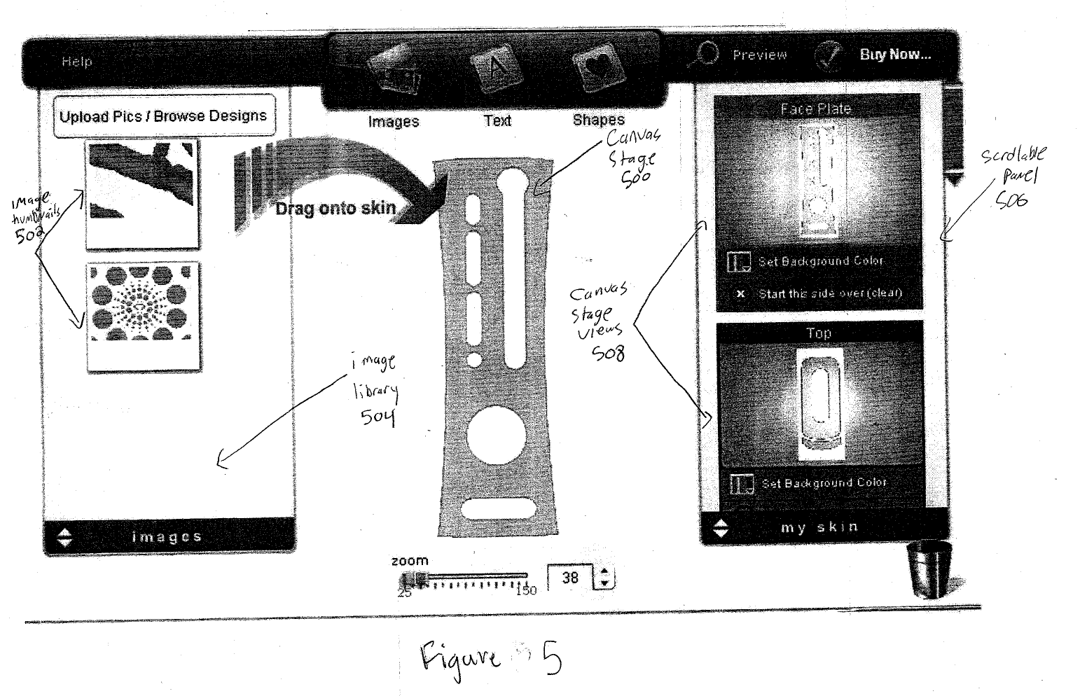

In some embodiments, the application interface includes a scrollable panel 506 (as shown in FIG. 5) containing selectable thumbnail-sized views 508 of each canvas stage. These thumbnail-sized views enable a user to view real-time screenshots of the design in progress and quickly select between different canvas stages. In one embodiment, the various canvas stages or surface representations may be positioned on-screen to be viewed as a single unit (e.g., in the staging area or during a preview discussed above with reference to blocks 210-212).

Once the user has provided any desired customization data for the selected surface or surfaces (shown at block 232 and block 234), control then resumes with user selection, and the process repeats per block 208. In this manner, the user can continue to refine his skin, save his work for later modifications, or designate that the skin is finally ready to be rendered and scheduled for print.

FIG. 4 is a flow diagram illustrating an exemplary method of receiving customization data according to one embodiment of the present invention. The depicted method can enable a user to input data in the application 104 for processing and subsequent output within a specification file. The output specification 110 can then be transmitted to a server 120 for high-resolution rendering and print scheduling.

At block 402, input is initially received from a user. As mentioned above, the user interface within the application 104 may take on any number of forms, styles, or configurations. In one embodiment, a graphical user interface is presented to the user including one or more staging areas, a color selection pallet, a set of navigational controls, and menus for selecting various images, font styles, shapes, filters, effects, and other options. The interface may be implemented using standard GUI components (for example, scroll panels, sliders, slide bars, radio buttons, spin boxes, text fields, status bars, etc.), with customizable or proprietary GUI components, or as a purely textual interface.

At block 404, it is determined whether the user has selected a new background color for the selected surface. The background color may be selected from a color pallet, color spectrum, set of RGB sliders, or by various other means. In some embodiments, the application 104 allows a user to adjust the opacity/transparency level of the background in order to control how an image overlay appears when positioned over the background. In some embodiments, the level of grayscale may also be adjusted. Once color settings have been determined, the new background color and corresponding settings are then set at block 406.

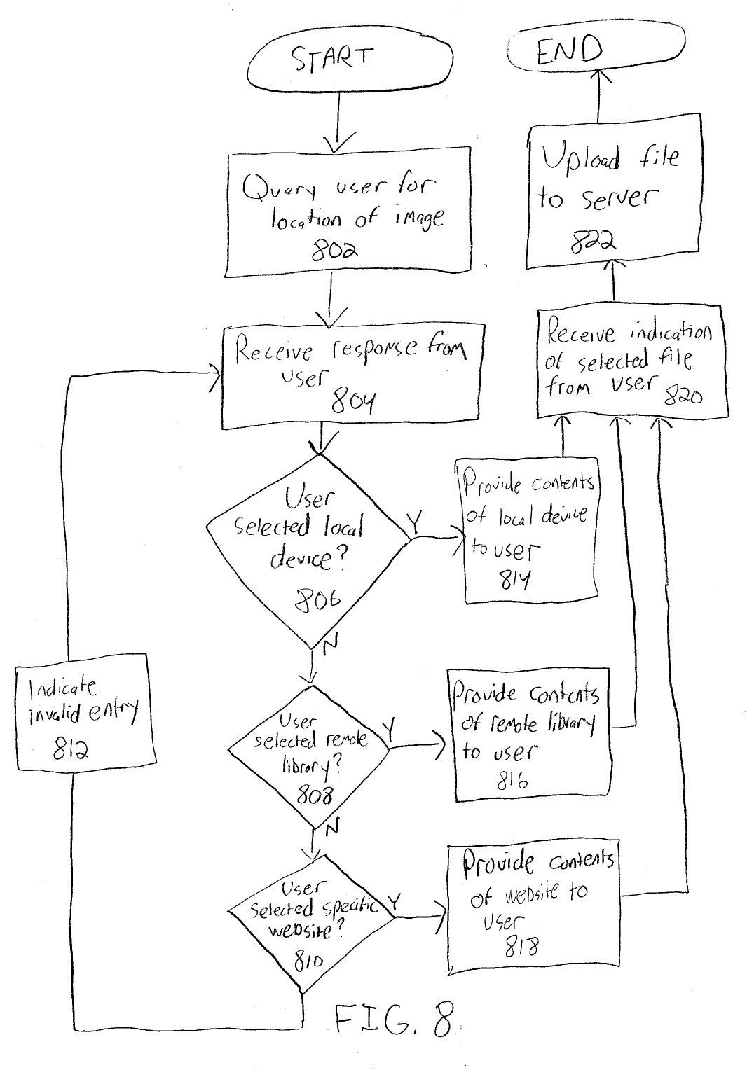

At block 408, it is determined whether the user has requested to add an image to the selected surface. The image may be selected from a variety of sources including the client device 100, an external website (e.g., as by a provided URL), or from one or more content libraries 124 associated with the server 120. Images of a variety of formats may be utilized with the application 104, including, without limitation, GIF, JPG, PNG, TIF, and SWF formats. The process of selecting an image selection and transfer is discussed in more detail below (see, e.g., FIG. 8 and accompanying text). In one embodiment, once the appropriate image files have been uploaded to the server (as depicted at block 410), the images are then processed at the server so as to create copies of the images in smaller resolutions. These processed images 134 are then received at the client device 100 (block 412), and a corresponding set of thumbnails may then be available for selection from the application interface.

For example, FIG. 5 is a screen capture of a graphical user interface for use with an interactive application according to one embodiment of the present invention. As shown by the figure, an image library panel 504 includes a set of image thumbnails 502 which may be dragged and dropped onto the canvas stage 500. In some embodiments, once a thumbnail 502 is dragged upon the canvas stage 500, the image is automatically fitted to the selected surface, and the user can then manipulate the image non-linearly. More specifically, the application 104 may enable the user to position the image about the canvas stage (e.g., via a mouse or arrow keys), resize or rotate the image (e.g., by dragging on-stage handles located at the corners of the image or by using panel sliders), adjust transparency settings associated with the image, or specify other image editing options. The various commands for customizing the image are then received by the application at block 414.

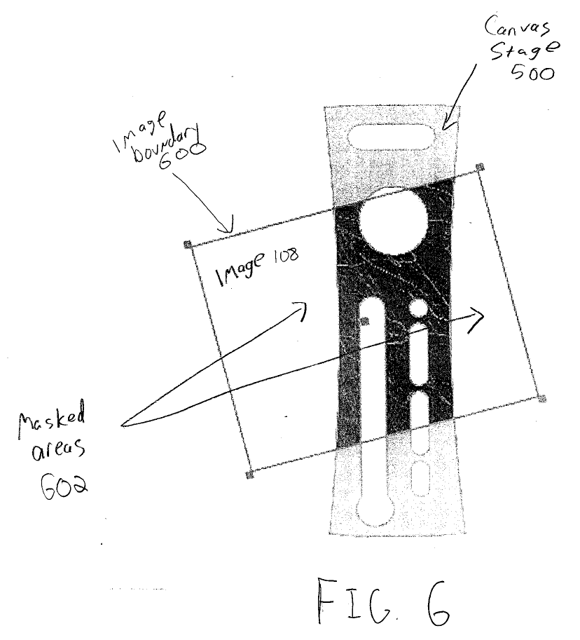

In some embodiments, a representation of the manipulated image can appear within a workspace of the application interface, and may be animated as the user manipulates one or more virtual controls. For example, FIG. 6 is a representation of an image (defined by image boundary 600) being rotated upon a canvas stage 500. As shown by the figure, a visual representation of the image overlay upon the canvas stage 500 enables the user to clearly determine which regions of the image 108 are positioned above it. Optionally, portions of the image extending beyond the canvas stage 500 may be masked in order to further enhance performance or overall visibility of the application interface. These portions of the image are depicted in FIG. 6 as masked areas 602.

In some embodiments, the application 104 allows the user to easily copy and paste graphical data from a clipboard. In one embodiment, copied objects display a “ghost-image” that animates a semi-transparent copy of the graphic toward a paste-from-clipboard icon. A clipboard graphic may then emerge beneath the paste icon containing a copy of the graphic displayed on the clipboard. In one embodiment, rolling the mouse over this icon will display the same clipboard graphic with the current object displayed within. If the user copies an entire canvas stage to the clipboard, the canvas thumb will display the same animation and the clipboard will display the canvas state's screenshot from the point in time that it was copied. Pressing the paste-from-clipboard icon will paste the contents of the clipboard on the current canvas stage. In one embodiment, if the user chooses to copy an entire canvas stage to all other sides, an animation with multiple “ghost images” of the canvas thumb will animate towards the other sides in the panel and duplicate the user object on all other sides, but the contents of the clipboard will remain unchanged.

Referring again to FIG. 4, if it is determined that the user has generated a request to add text to the selected surface or over an image (as shown at block 416), the selected text is then determined at block 418. This may be accomplished by reading input from one or more text fields appearing in the application interface.

Text customization commands may then be received at block 420. These commands include, without limitation, commands for changing the font, position, size, transparency, tint, or boldness of the input text. In some embodiments, the user may select a font from a list of predefined fonts. In one embodiment, if information for the selected font is not already stored within the memory 102 of the client device 100, the requested font may be downloaded via an active connection to the Internet. In one embodiment, the scale, position, and color of the text may be cached locally in order to present the user with a seamless switch if a new font is subsequently selected from a font selection menu.

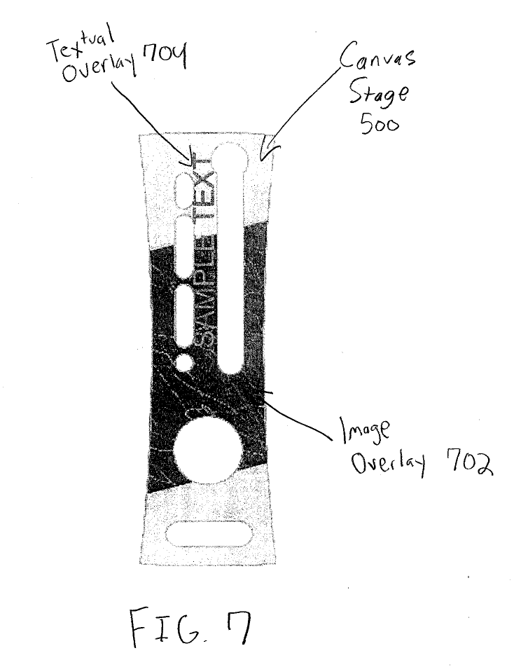

An example of text inserted upon a canvas stage is depicted in FIG. 7. As shown by the figure, the canvas stage 500 includes an image overlay 702 as well as textual overlay 702. Note that in some embodiments, the ordering of layered objects (text, images, flows, effects, etc.) can be adjusted within the application interface 104.

Returning again to FIG. 4, at block 422, if it is determined that the user has generated a request to add a shape to the selected surface, the selected shape can be determined at block 424. The shapes may be vector-based (i.e., mathematically defined or based upon points, lines, curves, and colors) as opposed to being pixel-based (where each pixel of an image is defined by a combination of color and/or grayscale data). Advantageously, this allows shapes to be infinitely scalable and therefore adapted to fit a wide range of surface dimensions.

Shape manipulation commands are then received at block 426. These commands may include, without limitation, commands to scale, tint, or colorize the shape, commands to position the shape upon the canvas stage 500, commands to rotate the shape, etc. Note that shapes and other vector-based artwork may be provided from a local source (e.g., as contained within a package of downloadable shapes installed within the memory 102 of the client device 100 during the initial deployment of imaging software 126), from an external website (e.g., a provided URL), or from a content library disposed within a server 120 according to embodiments of the present invention.

At block 428, if it is determined that the user wishes to add filters or effects to the selected surface, these selected filters or effects may then be applied at block 430. The selected filters include, without limitation, blur, Gaussian blur, sharpen, drop-shadows, brighten, tint, etc. In some embodiments, third-party effects such as red-eye removal and Sepia toning can also be applied.

In some embodiments, the user may also select an image border to add to a specific image. For example, in one embodiment, the user can specify a burnt paper border to give design an old “treasure map” feel. A variety of other possible borders, frames, and other effects may be downloadable from the content library 124 of the server 120.

FIG. 8 is a flow diagram illustrating an exemplary method of providing a selected image to a server in accordance with one embodiment of the present invention. As stated above, the application 104 allows a user to specify an image from either a local source (e.g., memory disposed within a computer, camera, handheld device, etc.) or a remote source (e.g., an external website such as Shutterfly®, Snapfish®, Google Images™, Facebook®, etc.). According to one embodiment, once the image is selected, it may be then transferred to the user directory 130 within the memory 122 of the server 120. In one embodiment, the server 120 is adapted to create a lower resolution version of the image (and optionally, a thumbnail of the image). This content is then provided to the client device 100, thereby enabling a quicker download, smaller memory use within the application 104, and less computationally-intensive imaging operations (i.e., the user can experience better performance moving the image data around within the application 104).

At block 802, the user is queried for the location of an image, and the response from the user is received at block 804. The interface for this input can be implemented in a variety of ways, including a navigational panel featuring standard GUI components (for example, scroll panels, sliders, icons, slide bars, radio buttons, text fields, status bars, etc.), an interface featuring custom-built or proprietary GUI components, or as a purely text-driven interface.

At block 806, if the user has selected a local device, the contents of the local device may then be provided to the user. In one embodiment, the user is first prompted to select a local device from a list of available devices (e.g., an external hard drive, available partitions within an internal hard drive, a peripheral device connected via a serial bus cable, etc.). The contents of the selected device may then be provided to the user as a navigational menu of files and directories. In one embodiment, the user can specify the path of the file directly within an available text field. A pointer or other indication of the location the selected file (or the file itself) is received at block 820, and the file is then uploaded to the server at block 822.

At block 808, if it is determined that the user wishes to select a file from the remote library (such as content library 124), the contents of the remote library are provided to the user at block 816. In some embodiments, the remote library is adapted to be presented to the user as a set of navigable folders which are arranged by category. For example, one folder may contain “background patterns,” another may contain images of “animals,” another may concern “sports,” “landscapes,” etc. Optionally, the remote library may contain references to files stored within other servers, or otherwise be adapted to request content from one or more file servers or network-attached storage systems. Once an indication of the selected file is determined at block 820, the file may then be uploaded to the server 120 at block 822 (e.g., as within the user directory 130). If the requested image is already stored within the memory 122 of the server 120, a reference or pointer to the image may be written to the user directory 130 in the alternative.

At block 810, if it is determined that the user has selected an image from a specific website, the contents of the website may then be presented to the user at block 818. In one embodiment, the contents of the website are provided as a listing of files and directories. Optionally, one or more extension filters may be used to mask content that is not compatible with the application 104 (e.g., MP3, MPG, EXE, etc.). Once an indication of the selected file is determined at block 820, the file may then be uploaded to the server 120 at block 822 (e.g., as within the user directory 130). As in the prior case, if the requested image is already stored somewhere within memory 122, a reference or pointer to the image may be written to the user directory 130 in the alternative.

If the user has input an unrecognizable command, an error message or invalid entry can be displayed at block 812, and the process repeats per block 804. Note that in some embodiments, images transferred to the server 120 may be automatically deleted or archived after a designated time period in order to free up space within the memory 122.

FIG. 9 is a flow diagram illustrating an exemplary method of rendering and printing a skin created by an interactive application according to one embodiment of the present invention. In one embodiment, the rendering process uses an XML file generated by the application 104 and attempts to rebuild the design using high-resolution versions of the media used.

At block 902, it is determined whether there are any unprocessed or new orders. In one embodiment, an application resident within the memory 122 of the server 120 (e.g., a .NET application) checks a database in order to determine whether any orders are still unprocessed. If unprocessed orders are present, the next unprocessed order is read at block 904. Otherwise the process terminates (or alternatively, sleeps for a designated time period before resuming at block 902).

At block 906, the output specification, images, and support files are loaded into a rendering application (e.g., Adobe Flash™). For larger print orders expected to exceed the memory limits of the rendering application, a separate rendering process may be used in the alternative (e.g., an application supporting Adobe portable document format (PDF) instead of shockwave flash (SWF)). The skin is then rendered at block 908. In some embodiments, the application resident within the memory 122 of the server 120 (e.g., the .NET application) may piece together the resulting image in quadrants in order to support a larger output format.

At block 910, output from the rendering process is converted into a print-ready format. In one embodiment, the print-ready format consists of a Joint Photographic Experts Group image (JPG), but other formats are also possible according to embodiments of the present invention. The order may then be designated as complete at block 912, and the image marked as ready for production.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
providing a first application to a user, wherein the first application is adapted to enable the user to graphically edit a copy of an image associated with a device template;
receiving a specification from the user, wherein the specification is adapted to describe an edited copy of the image;
creating a rendered image according to the specification; and
printing the rendered image.

2. The method of claim 1, wherein the device template comprises an extensible markup language file and an image file.

3. The method of claim 1, wherein the specification comprises an extensible markup language file.

4. The method of claim 2, wherein the extensible markup language file comprises data indicating the shape of at least one surface.

5. The method of claim 2, wherein the extensible markup language file comprises data indicating the location of an image, wherein at least a portion of the image is adapted to appear within the edited copy of the image.

6. The method of claim 1, further comprising:
receiving the location of a selected image from a user;
receiving the selected image;
generating a copy of the selected image in a resolution that is smaller than the resolution of the selected image; and
providing the copy of the selected image to the user,
wherein the copy of the selected image is adapted to enable the user to perform faster graphics operations when positioning the copy of the selected image upon the copy of the image associated with the device template than when positioning the selected image upon the copy of the image associated with the device template.

7. The method of claim 1, wherein the first application is further adapted to enable the user to create the device template.

8. The method of claim 7, wherein the first application comprises logic adapted to assist the user with creating the device template by automatically plotting points within a specified path.

9. The method of claim 7, wherein the first application comprises logic adapted to assist the user with creating the device template by automatically identifying edges within an image.

10. A computer readable medium comprising instructions which, when executed by a computer, perform a process comprising:
receiving a set of data indicating dimensions of at least one surface configuration;
displaying a visual representation of said at least one surface configuration;
receiving a set of commands comprising graphical edits to said at least one surface configuration;
creating a specification from the set of commands, wherein the specification is adapted to indicate an edited version of said at least one surface configuration; and
transferring the specification to a remote device, wherein the remote device is adapted to generate a rendered image from the specification, and wherein the remote device is adapted to print the rendered image.

11. The computer readable medium of claim 10, wherein the set of commands comprises a command to insert a graphical object upon the surface configuration.

12. The computer readable medium of claim 11, wherein graphical object is adapted to be resized.

13. The computer readable medium of claim 11, wherein graphical object is adapted to be rotated.

14. The computer readable medium of claim 11, wherein graphical object is adapted to be repositioned upon the surface configuration.

15. The computer readable medium of claim 11, wherein the graphical object comprises an adjustable transparency level.

16. The computer readable medium of claim 10, wherein a new specification is created after each graphical edit.

17. The computer readable medium of claim 16, wherein the process further comprises receiving a command to load a designated specification.

18. An apparatus comprising:
a file server adapted to provide an application to a user, wherein the application is adapted to enable the user to create a design upon a visual representation of a specified area;
a content library adapted to enable the user to download data comprising visual representations of specified areas;
a receiving module adapted to receive a specification of a design created by the user;
a rendering module adapted to generate a rendered image from the specification received at the receiving module; and
a print module adapted to print the rendered image.

19. The apparatus of claim 18, wherein the content library is further adapted to enable the user to download content for use within the design.

20. The apparatus of claim 19, wherein the content comprises a pixel-based image.

21. The apparatus of claim 19, wherein the content comprises a vector-based image.

22. The apparatus of claim 19, wherein the content comprises an image border.

23. The apparatus of claim 19, wherein the content comprises a downloadable font.

24. The apparatus of claim 19, wherein the content comprises a downloadable effect.

25. The apparatus of claim 19, wherein the content comprises a scalable shape.
